(19) United States
(12) Patent Application Publication
(10) Pub. No.: US 2005/0221957 A1
(43) Pub. Date: Oct. 6, 2005

(54) Electro-mechanical gear speed reduction mechanism for car seat back adjustment

(76) Inventor: Wang Shang Sheng, Ruian City (CN)

Correspondence Address: LAW OFFICES OF CLEMENT CHENG, 17220 NEWHOPE STREET #127, FOUNTAIN VALLEY, CA, 92708, US

(21) Appl. No.: 11/094,563

(22) Filed: Mar. 30, 2005

(30) Foreign Application Priority Data
Apr. 5, 2004 (CN) 2004200478763

(51) Int. Cl. F16H 61/26

(52) U.S. Cl. 477/162

(57) ABSTRACT

An electromechanical gear speed reduction mechanism for car seat back adjustment has a worm rod driving and meshing with a worm gear. The worm gear is co-axially affixed to an input gear. The input gear meshes with an output gear an output gear at an output end. The output gear at the output end moves the car seat back angle.

### FIELD OF THE INVENTION

The field of the invention is an electromechanical gear speed reduction mechanism for car seat back adjustment. This practical new design is about one kind of reduction mechanism; particularly, it involves one kind of electromechanical gear speed reduction mechanism for car seat back adjustment.

### BACKGROUND

To deliver soft and comfortable motion during car seat back angle adjustment, an ordinary electromechanical gear speed reduction mechanism used for car seat back angle adjustment would require an electromechanical gear speed reduction mechanism that has a high speed reduction. Unfortunately, such gears are prone to be damaged.

Presently and generally, double gears or larger gears are used to bolster the strength of the gears. As far as the double gear structure is concerned, FIG. 1, it uses the two sides of one worm rod (1) to drive, respectively, two worm gears (2) to turn in the same direction. On each of the two worm gears (2) is affixed a plastic input gear (3). The two input gears (3), together, drive one output gear (4) and seat back axle (5).

This kind of worm gear (2) requires two sections of threads that run in opposing directions, making it harder to work with and placing a high demand on the dies. As a result, the cost is higher and more space is taken up. As far as the bigger gear structure is concerned, it would increase the difficulties in installing the seats and would reduce the comfort of riding in a car. It can be seen that the above options have inherent shortcomings.

### BRIEF DESCRIPTION OF THE DRAWINGS

FIG. 1 is an illustration of the structure of a double gear

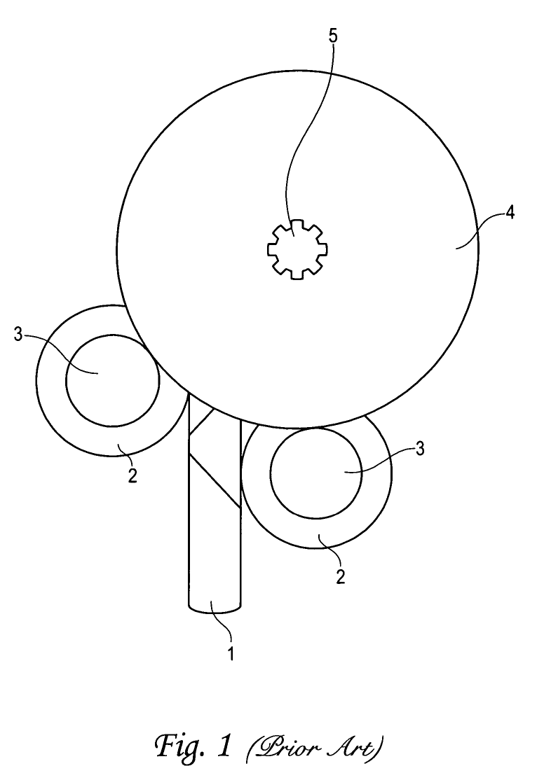

FIG. 2 is an illustration of this practical and new structure.

### SUMMARY OF THE INVENTION

This practical new design overcomes the shortcomings of the current technology and provides an electromechanical gear speed reduction mechanism for car seat back adjustment seat that is strong, that is easier to work with, and that has a compact structure.

The electromechanical output end of this practical new kind of electromechanical gear speed reduction mechanism for car seat back adjustment is connected to a worm rod; the worm rod meshes with a worm gear; said worm gear is co-axially affixed to an input gear; and said input gear meshes with the output gear.

Without changing the overall speed ratios, this practical new electromechanical gear speed reduction mechanism for car seat back adjustment adopts a two stage speed reduction, bolsters the strength of the input gear, facilitates the fabrication and installation, provides an overall compact gear speed reduction mechanism structure, has a smaller size and, at the same time, satisfies the demands for strength and longevity of the electromechanical gear speed reduction mechanism.

### DETAILED DESCRIPTION OF THE PREFERRED EMBODIMENT

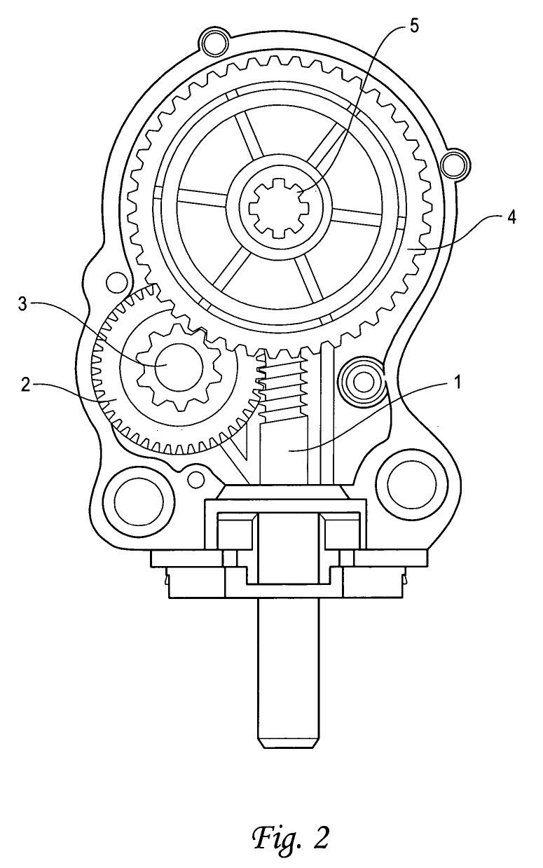

Referring to FIG. 2, the following is a detailed description of the actual implementation of this practical new design.

The electromechanical output end of this practical new design of electromechanical gear speed reduction mechanism for car seat back angle adjustment is connected to a worm rod 1. The worm rod 1 meshes with a worm gear 2. The worm gear 2 is co-axially affixed to an input gear 3. The input gear 3 meshes with the output gear 4. The output end of said output gear 4 is connected to the car seat back and drives the movement of the car seat back.

To bolster the strength of the gear speed reduction mechanism, input gear 3 may be made with metal. Worm gear 2 and/or output gear 4 may be made with plastic.

Through a two stage speed reduction, the gear speed reduction mechanism of this practical new design can reduce the output revolution speed of 3000±800 RPM to 22±2 RPM; the first stage worm rod and worm gear speed reduction ratio is 25-45:1, the preferred choice is 37:1; the speed reduction ratio of the second stage gear speed reduction is 34-43:8-12, and the preferred choice is 37:9.

Of course, based on the above power transmission mechanism structure, including the gears, technical people in this field can easily compute and design the corresponding two stage speed reduction mechanism with the known input and output speed change ratio.

The center of the inner axis of the output gear adopts a plum flower shaped keyhole 5 enhancing integration between gearing and the seat back angle adjustment axle. At the same speed ratio and strength, this structure enables easier fabrication, installation and, at the same time, satisfies the demands for strength and longevity of the electromechanical gear speed reduction mechanism.

1. An electromechanical gear speed reduction mechanism for car seat back adjustment comprising: one worm rod driving and meshing with one worm gear; wherein the worm gear is co-axially affixed to an input gear, wherein the input gear meshes with an output gear an output gear at an output end; wherein the output gear at the output end moves the car seat back angle.

2. The electromechanical gear speed reduction mechanism for car seat back adjustment device of claim 1, wherein the input gear is made of metal.

3. The electromechanical gear speed reduction mechanism for car seat back adjustment device of claim 2, wherein at least one of the worm gear or output gear is made of plastic.

4. The electromechanical gear speed reduction mechanism for car seat back adjustment device of claim 1, wherein the speed reduction ratio between the worm rod and the worm gear is 25-45:1, and the gear speed reduction ratio is 34-43:8-12.

5. The electromechanical gear speed reduction mechanism for car seat back adjustment device of claim 4, wherein the reduction ratio between the worm rod and the worm gear is 37:1, the gear speed reduction ratio is 37:9.

6. The electromechanical gear speed reduction mechanism for car seat back adjustment device of claim 1, wherein the center of the inner axis of said output gear is constructed in the form of a plum-flower shaped keyhole.
